(19) United States
(12) Patent Application Publication
(10) Pub. No.: US 2014/0004234 A1
(43) Pub. Date: Jan. 2, 2014

(54) SYSTEM AND METHOD TO EXTEND COOKING OIL LIFE IN FRYERS

(71) Applicant: FRYMASTER L.L.C., Shreveport, LA (US)

(72) Inventors: David E. MOSTELLER, Shreveport, LA (US); Eric N. PITCHFORD, Shreveport, LA (US)

(73) Assignee: Frymaster L.L.C, Shreveport, LA (US)

(21) Appl. No.: 13/929,616

(22) Filed: Jun. 27, 2013

Related U.S. Application Data
(60) Provisional application No. 61/665,184, filed on Jun. 27, 2012.

(51) Int. Cl. A47J 37/12

(52) U.S. Cl. CPC A47J 37/1266
USPC 426/231; 99/330

(57) ABSTRACT

A fryer system and method of extending oil life in fryer pots by minimizing the effects of oxygenization, hydrolysis and lack of oil replenishment during the cook cycle. The fryer system includes a controller that controls an on time and an off time of the fryer pots according to a use schedule. The use schedule levels or equalizes the on time use among all of the fryer pots. The controller includes a processor that executes instructions stored in a memory to control the on time use and off time use of the fryer pots as well as the use of filtration based on an elapse of a predetermined number of cook cycles of a stopped fryer pot since the oil was last filtered.

### RELATED APPLICATION

This application claims priority to U.S. Provisional Application No. 61/665,184, filed on Jun. 27, 2012, the entire contents of which are hereby incorporated herein.

### BACKGROUND OF THE DISCLOSURE

1. Field of the Disclosure

The present disclosure relates to a fryer system and method of extending cooking oil life in fryers by minimizing the effects of oxygenation, hydrolysis and lack of oil replenishment during the cooking cycle.

2. Description of Related Art

Cooking oil, sometimes referred to as fat or shortening, used in deep fat frying is both the method of heat transfer and the substance absorbed by the fried product which provides the taste and “mouth feel” that makes deep fat fried foods so universally popular. However, wasted oil discarded due to deterioration during the deep fat frying process costs the restaurant industry millions of dollars each year. One of the problems with oil is deterioration in the fryer pot over a period which varies from a few days to a few weeks and since the deteriorated oil contributes a bad taste to the food and is unhealthy if ingested, it must be discarded. Frying oil is considered unfit for human consumption when any one of a number of attributes exceeds limits set by the individual restaurant or by various governmental bodies. The three most common attributes which restaurants monitor are Free Fatty Acids (FFA), Total Polar Materials (TPM), and Color. All of these attributes are relevant to the determination as to the state of deterioration of the oil. However governmental regulation currently is primarily focused on Total Polar Materials and Free Fatty Acids. While the discard value of oil may be as much as 30% of its initial value due to its use in bio-fuel production, the cost of fresh non-trans fat oil may approach $1.00/pound. So the opportunity for saving oil waste is very large.

Most efforts to extend oil life have centered on various filtering processes which involve frequent filtering or the use of sophisticated and expensive filter aids. Mechanical filtering processes have proved only marginally effective at extending oil life and do not solve the overall oil deterioration problem. The reason that filtering is not the ultimate solution can be easily understood is that the crumb sized byproducts of frying are not the primary cause of oil deterioration. Most of the harmful byproducts of cooking exist at a molecular level and cannot be easily removed by mechanical means. While mechanical means of removal are not always effective, there exist other methods.

Certain filter aids have proven to be effective in removing some of the harmful cooking byproducts by adsorption. The best filter aid thus far tested is composed of magnesium silicate which is considered essential when filtering. Unfortunately it also absorbs a certain amount of oil which is discarded each time the filter is discarded. However, the positive effects of the use of magnesium silicate filtration significantly outweigh the cost of the oil discarded. Nevertheless, to this point, no one has understood how to completely address the oil deterioration problem and/or provided an organized, manageable, and effective regimen which can actually be used in a restaurant environment to solve the problem.

The primary three factors that contribute to oil deterioration and degradation are 1) oxygenation, 2) hydrolysis and 3) lack of a sufficiently high oil turnover ratio to offset the degraded oil that results from oxygenation and hydrolysis.

Oxygenation of the oil is accelerated by the oil being maintained at high temperatures. Oil deteriorates at an exponentially increasing rate as oil temperature increases. In the restaurant environment, peak fryer food cooking capacity is not needed at all times. Therefore, there is an opportunity to either turn off or reduce to an idle mode fryers that are not needed. Having unneeded fryers turned off or in an idle mode, reduces oil deterioration due to elevated temperatures.

Further, the rate of oxygenation is proportional to the surface area of the oil and as previously stated increases exponentially as the temperature of the oil rises. The rate of deterioration of oil at 335 degrees is approximately 36% higher than the rate of deterioration at 290 degrees but is slightly more than double the 290 degree rate at 360 degrees.

Further, deterioration of oil due to oxygen is not significantly affected by the cooking process. So fryer pots sitting idle at temperature (depending subtly on other conditions) will frequently deteriorate faster than fryer pots in which cooking occurs due to the lack of any oil turnover. The time a fryer pot is exposed to air multiplied by an appropriate temperature factor can be termed “oxygen minutes.” Controlling the oxygen minutes is very important in minimizing the negative effects of both high heat and air exposure. The coordination of the off, idle and cooking modes in the store environment and taking advantage of the reduced cooking capacity to minimize oil deterioration must be optimized.

Further, during the cooking process moisture is introduced into the oil (hydrolysis) from the nature of the cooking process. Saturation levels of moisture in the oil are obtained quickly, and often after just a single cook cycle. Unfortunately, high moisture levels require several hours to naturally return to acceptable moisture levels. The capacity of oil to hold dissolved water, its saturation level, theoretically increases as the oil temperature increases. But as a practical matter during actual cooking tests, the observed concentration of water in oil was:

| Cooking Temperature | Water Content |
|---|---|
| 290 F. | .148% |
| 335 F. | .106% |
| 360 F. | .085% |
| Fresh Oil | .018% |
| After 10 minutes polish filter | .011% |

Further, the ability of oil to retain dissolved water increases as the oil deteriorates. Therefore there is a tendency once the oil starts to deteriorate for the process to accelerate as each step in the deterioration process leads to even more water retention during the next cook cycle. Water that is dissolved in cooking oil cannot boil away. In contrast, such oil must evaporate. While boiling occurs within a liquid, evaporation only takes place at the surface. Therefore, evaporation is a very slow process that can take hours. The minimization of “water minutes” the percentage of water present in oil multiplied by the number of minutes that the water is present is achieved in the disclosed process. In the context of a commercial cooking environment, cooking sporadically in several fryers has the end result of keeping the moisture levels high in all of the fryers in a system without any intervention.

Accordingly, focused cooking in specific fryers limits high moisture levels to a minimum number of fryers and therefore reduces the system rate of deterioration in the fryers due to moisture. A further method of minimizing deterioration due to moisture levels in cooking oil is to quickly remove moisture from the oil in the fryer pot once such fryer pot is placed in an idle status.

Removal of water from oil is critical because, while, after the oil becomes saturated further cooking does not result in any additional water buildup. Therefore, actively removing moisture from the oil prior to an extended period of non-cooking will reduce the rate of deterioration due to moisture, and necessarily before placing the fryer in idle mode. However, as previously noted the water will remain in the oil for a long time if not removed.

The third factor that greatly reduces the oil quality is lack of fresh replacement oil that is returned to the fryer pot. During the cooking process, cooking oil is gradually removed from the fryer and absorbed into food, removed by utensils and daily filtration and cleaning. The removal and replacement of the oil that is deteriorated by oxygenation and hydrolysis addressed previously and replaced by fresh non-deteriorated oil acts to improve the overall condition of the oil in the fryer pot. A measure of the oil replacement is called the turnover ratio and is calculated by dividing the daily quantity of oil removed from the fryer by the total fryer capacity. Higher turnover ratios improve the quality of the oil in the fryer. The way to solve the oil life problem is to either improve the refresh rate or lower the deterioration rate or affect both so that the rate of deterioration is offset by the rate of refreshment. The turnover ratio is most effectively improved by reducing the oil capacity of the fryer and by using a low oil volume fryer and limiting the rate of deterioration with regard to oxygenation and moisture retention.

For example, a 50 pound fryer pot with a replacement rate of 6 pounds per day would have a turnover ratio of 12%. A 30 pound fryer pot with the same 6 pound replacement rate per day would have a turnover ratio of 20%. This sort of turnover ratio difference is significant. The higher the turnover ratio, the greater is the salutary effect on the overall process. The equilibrium thus achieved extends the oil life so that it is constantly being refreshed by new oil and served to the customer before it deteriorates beyond its useful life.

Fryer pot rotation is necessary to assure that each fryer pot deteriorates and is rejuvenated in an equal manner over time. The reason this is important is that under normal conditions all fryer pots are filtered through a single filter each day. If one fryer pot is allowed to deteriorate at a higher rate than the others it will cross contaminate the other fryer pots due to the residue left behind having a catalytic effect on the other fryer pots when they are filtered through the same filter pad. This cross contamination by the most seriously deteriorated fryer pot has the effect of accelerating the deterioration of the less deteriorated fryer pots, thus dragging down the entire system. In addition, as previously mentioned as oil deteriorates its capacity to dissolve higher percentages of water is increased.

The present disclosure has recognized that efficient use of cooking oil for even cooking in each fryer pot of a fryer system achieves optimal quality of food cooked in each fryer pot of the fryer system. Optimal oil life is achieved when the deterioration level in oil in all fryer pots in the system is consistent and minimized. Accordingly, there is a need for a control system and process for tracking the deteriorated state of oil in each fryer pot and for adjusting the cooking and filter schedule to account for differences of oil quality. Further, there is a need to minimize the negative impacts on cooking oil of excessive elevated temperature, oxygenation, moisture, lack of oil turnover ratio, and filtration of cooking oil to minimize deterioration of oil in a system of fryer pots.

### SUMMARY OF THE DISCLOSURE

An embodiment of the fryer system of the present disclosure comprises a plurality of fryer pots and a filtration system that filters oil used in the fryer pots. A controller controls an on time use and an off time of the fryer pots according to a use schedule that levels the on time use among the plurality of fryer pots over a period of two or more days.

In another embodiment of the fryer system of the present disclosure, the on time use of the fryer pots is equalized over the period.

In another embodiment of the fryer system of the present disclosure, the use schedule rotates the on time use of the fryer pots from one to the next of the days.

In another embodiment of the fryer system of the present disclosure, the on time use of two or more of the plurality of fryer pots overlaps one another during a rush time.

In another embodiment of the fryer system of the present disclosure, any of the plurality of fryer pots that is not presently being used is controlled to an off status or an idle status.

In another embodiment of the fryer system of the present disclosure, the controller arranges for the filtration system to filter oil contained in one of the fryer pots that is not presently in use based on an elapse of a predetermined number of cook cycles of the one of the fryer pots since the oil was last filtered.

In another embodiment of the fryer system of the present disclosure, the controller further arranges for the oil to be cycled several times through the one of the fryer pots in a polishing process to remove water from the oil.

In another embodiment of the fryer system of the present disclosure, the controller comprises a processor that executes instructions stored in a memory to control the on time use and the off time of the plurality of fryer pots.

In another embodiment of the fryer system of the present disclosure, each of the fryer pots comprises a user interface and local controller. The processor communicates prompts to the user interfaces for the operator to initiate actions via the local controller to control the associated fryer pot, the actions including turn on, turn off, oil filtration, polish oil and/or add new oil.

In an embodiment of method of the present disclosure for a fryer system that comprises a plurality of fryer pots and a filtration system, the method comprises:

executing instructions with a processor for control of an on time use and an off time of the fryer pots according to a use schedule that levels the on time use among the plurality of fryer pots over a period of two or more days; and

sending prompts to an operator of the fryer system to turn the fryer pots on and off and to start and stop a filtering of the oil of a stopped fryer pot.

In another embodiment of the method of the present disclosure, the method further comprises:

generating a prompt for filtering the oil of an off time fryer pot based on an elapse of a predetermined number of cook cycles of an off time fryer pot since the oil was last filtered.

In another embodiment of the fryer system of the present disclosure, the method further comprises:

after filtering, polishing the oil of the off time fryer pot.

The present disclosure further provides for a fryer system including a plurality of fryer pots, and a controller that manages the filtration and on/off status of such fryer pots according to a schedule stored in the controller such that when the instructions are executed, a cooking process is enabled that emphasizes the intense use of each fryer pot while it is heated in order to optimize the turnover ratio of cooking while minimizing the heated minutes of the oil and the hydrolysis of the oil to minimize degradation due to heat exposure and water saturation. Each individual fryer pot coordinates all cooking activities such as menu items, cook temperatures and safety operations related to the heating system of the fryer pot.

The present disclosure further provides for a fryer system and methodology that provides for at least two fryer pots that have periods of overlapping use during predetermined rush periods, such as at lunch and dinner. In the non-rush periods of lower fryer pot usage, one of the two fryer pots is brought out of service to minimize the effects of excessive heat, hydrolysis and oxidation that such oil is exposed to during the cooking process. The present disclosure provides for different protocols that cover cooking periods including 12, 18 and 24 hours.

The present disclosure further provides for a fryer system and methodology that includes at least three fryer pots that have periods of overlapping use during predetermined and prescheduled rush periods, such as during lunch and dinner. In the non-rush periods, two of the three fryer pots are taken out of use to minimize the effects of excessive heat, hydrolysis and oxidation that such oil is exposed to during the cooking process. The present disclosure provides for different protocols that cover cooking periods including 12, 18 and 24 hours. The fryer pot that is first used each day is rotated to ensure that such first used fryer pot on a following day receives the benefit of a new filter, rejuvenated oil and a clean filter.

The present disclosure further provides for a fryer system and methodology that includes at least three fryer pots that have periods of overlapping use during predetermined and prescheduled rush periods, from lunch through dinner. In the non-rush periods, two of the three fryer pots are taken out of use to minimize the effects of excessive heat, hydrolysis and oxidation that such oil is exposed to during the cooking process. During the rush periods, at least two fryer pots are on to maintain cooking capacity and one fryer pot is off. The present disclosure provides for different protocols that cover cooking periods including 12, 18 and 24 hours. The fryer pot that is first used each day is rotated such that no fryer pot of the three is first used on successive days. By rotating the first fryer pot, such first used fryer pot on a day receives the benefit of a new filter, rejuvenated oil and a clean filter.

The present disclosure further provides for a fryer system and methodology that includes at least three fryer pots that have use during predetermined and prescheduled rush periods, from dinner through closing. In the non-rush periods, two of the three fryer pots are taken out of use to minimize the effects of excessive heat, hydrolysis and oxidation that such oil is exposed to during the cooking process. During the rush periods, at least two fryer pots are on to maintain cooking capacity and one fryer pot is off. The present disclosure provides for different protocols that cover cooking periods including 12, 18 and 24 hours. The fryer pot that is first used each day is rotated such that no fryer pot of the three is first used on successive days. By rotating the first fryer pot, such first used fryer pot on a day receives the benefit of a new filter, rejuvenated oil and a clean filter.

The present disclosure further provides for a system including a plurality of fryer pots, and a controller that manages the filtration and scheduling of such fryer pots according to a schedule stored in the controller such that when the instructions are executed a cooking process is enabled that emphasizes the intense use of first and second pots during a predetermined period of time and then deactivates such fryer pots and commences cooking in a third fryer pot during a shorter period of time than the first predetermined period of time for a total cooking time of 12 hours. At the start of a next 12 hour period, the first fryer pot that was used during the first predetermined period of time is reserved for later use during the shorter period of time that begins after the first predetermined period of time. Simultaneously, the fryer pot that was used during the shorter period of time, the third fryer pot, is used during the first predetermined long period of time along with the second fryer pot. The benefit that is achieved by rotating the first fryer pot to the later cooking period is that the second fryer pot that is used at the start of the second twelve hour time period receives a new filter that automatically absorbs some of the cooking oil in the fryer pot so that the oil will have to be replenished due to the decreased oil volume.

The present disclosure further provides for a method of maintaining optimal quality in a deep fryer system of the type having a housing with at least first and second fryer pots that are sized to hold a quantity of cooking liquid for cooking a food product. The fryer system contains a filtration system that is configured to filter cooking liquid of the first and second fryer pots during operation and a controller that supplies signals to the filtration system and to the first and second fryer pots, the controller having a computer readable medium having computer executable instructions that when executed implement a method stored on a processor. The method includes the steps of: a) providing a signal to a controller of the first fryer pot that prompts a user to commence cooking in the first fryer pot; b) receiving a signal that activates the first fryer pot and begins operation of a heat source to maintain a supply of oil in the first fryer pot at a predetermined temperature for a predetermined time to cook the food product during a cooking cycle; c) assessing the need to filter the cooking oil in the first fryer pot based on a signal that is received; and wherein if i) the signal is above a predetermined threshold, sending a signal to commence a filtration cycle in the first fryer pot and sending a signal to a controller of the second fryer pot to prompt a user to commence a cooking cycle in the second fryer pot; and if ii) the signal is below a predetermined threshold, sending a signal to the controller of the second fryer pot to prompt a user to commence a cooking cycle in the second fryer pot or continue the cooking cycle; and d) wherein the first fryer pot and the second fryer pot are simultaneously in operation until a signal is received to commence a filtration cycle in the first fryer pot or the second fryer pot.

The present disclosure requires a determination of a minimum number of fryer pots that are used and heated at a given time thereby eliminating the oxidation of oil in fryer pots which are simply sitting idle, preventing hydrolysis of unneeded fryer pots due to casual loading, and maximizing the turnover of oil in fryer pots which are being heavily used.

The present disclosure further provides for a system and method that polishes the oil in a fryer pot as soon as intense period of heating in a fryer pot has ceased. Polishing rapidly cycles the cooking oil through the filtration system for a predetermined period of time and eliminates water from such oil and cools the oil that is pumped through filter and fryer plumbing. Polishing immediately stops the exposure of cooking oil to water and therefore minimizes the negative effects of water and rapidly cools the oil to minimize the exposure of the oil to elevated temperatures. The fryer pot is then allowed to cool further naturally and remains in that state until its next scheduled period of use.

Therefore, it is essential to also rotate the dynamic overlapping process between each fryer pot in the system for load leveling purposes. This rotation is necessary to assure that each fryer pot deteriorates and is rejuvenated in an equal manner over time.

In carrying out the principles of the present invention, in accordance with a preferred embodiment thereof, a deep fat frying apparatus and method of operation is provided in which oil management functions including the transfer of oil, oil polishing/filtration, and the fill and dispose functions are automated by means of a control system which has electric motor operated valves to control the flow of oil, exposure of fryer pots to heaters, moisture, and oxidation. The disclosure provides for a control system for tracking the deteriorated state of oil in each fryer and adjusting the cooking and filter schedule to account for differences, based on exposure of oil in a fryer pot to elevated temperature, moisture and oxidation.

The present disclosure includes a control system that communicates between all fryer subsystems and user interface components to extend oil life resulting in lower oil cost due to minimization of deteriorating conditions. By minimizing exposure to deteriorated oil conditions, consistent food quality remains in the optimum quality range for TPM, FFA and color for a longer period of time.

### BRIEF DESCRIPTION OF THE DRAWINGS

Other and further benefits, and advantages and features of the present disclosure will be understood by reference to the following specification in conjunction with the accompanying drawings, in which like reference characters denote like elements of structure.

FIG. 1 is a perspective view of the fryer system showing a the housing with three fryer pots, that implement the method of the present disclosure;

FIG. 2 is a rear perspective view of a fryer pot according to the present disclosure;

FIG. 3 illustrates a further perspective view of a fryer pot according to the present disclosure;

FIG. 4 illustrates various components of a portion of the plumbing system according to the present disclosure;

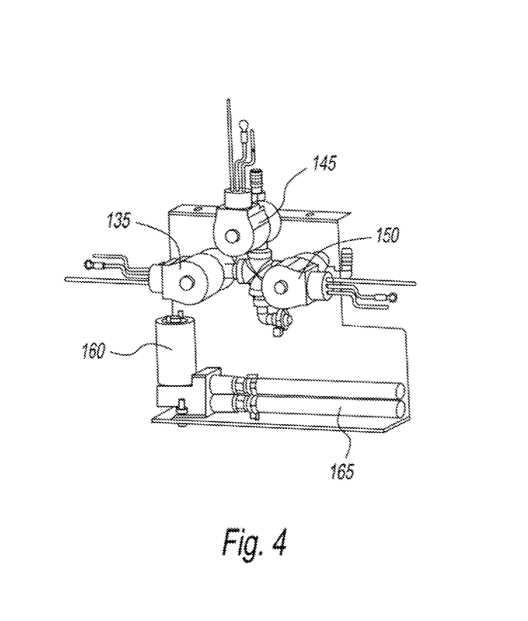

FIG. 5 illustrates a schematic diagram of the computer and processor for executing the instructions to carry out the methodology of the present disclosure;

FIG. 6a illustrates a schematic diagram showing the fryer pots and the master control function of the several fryer pots, according to a first embodiment of the control system of the present disclosure;

FIG. 6b illustrates a schematic diagram showing an alternative configuration of the control of the several fryer pots according to the present disclosure;

FIGS. 7a through 7c illustrate a cooking schedule for a system having two fryer pots that is implemented by a method of the present disclosure;

FIG. 7d illustrates a flow chart for carrying out the schedule of FIGS. 7a through 7c.

FIGS. 8a through 8c illustrate a cooking schedule, featuring heavy lunch and dinner schedule, for a system having three fryer pots that is implemented by a method of the present disclosure;

FIGS. 9a through 9c illustrates a cooking schedule, featuring a heavy cooking schedule from 11 am until 7 pm, for a system having three fryer pots that is implemented by a method of the present disclosure;

FIGS. 10a through 10c illustrates a cooking schedule, featuring a heavy cooking schedule from 5 pm until 12 am, for a system having three fryer pots that is implemented by a method of the present disclosure;

FIGS. 11a through 11c illustrate a cooking schedule, featuring a heavy cooking schedule from 5 am until 12 pm, for a system having three fryer pots that is implemented by a method of the present disclosure;

FIG. 12 illustrates a flow chart that shows the process of the fryer system the implements the schedule of FIGS. 8a through 8c, FIGS. 9a through 9c, FIGS. 10 through 10c and FIGS. 11a through 11c; and

FIG. 13a shows a comparison between total polar materials present in a contaminated store unit and a store unit using a schedule according to the present disclosure; and

FIG. 13b is a graph of a comparison of the percentage of free fatty acids between a contaminated store unit using a schedule according to the present disclosure.

### DETAILED DESCRIPTION OF THE PREFERRED EMBODIMENT

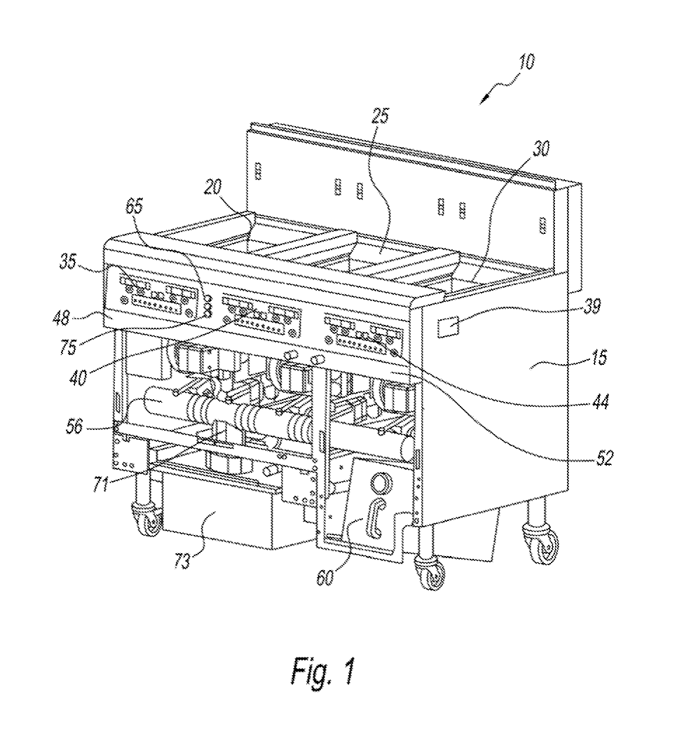

Referring to FIG. 1, a front perspective view of a fryer system is shown, and generally referred to by reference numeral 10. Fryer 10 has a housing 15 and three fryer pots 20, 25 and 30. Pots 20, 25 and 30 each contains oil for deep frying foods commonly used in the commercial food industry. Fryer 10 has a controller 48 that controls each fryer pot 20, 25 and 30. Controller 48 is in communication with fryer pots 20, 25 and 30 via fryer controllers 35, 40 and 44 to maintain overall control of fryer system 10. Each controller 35, 40, and 44 has a user interface 52 with a display panel that is capable of showing text, lights for instruction and conveying signals to user.

Housing 15 contains a heating system comprising individual gas or electric heaters. Heaters are conventional heaters which are operated and controlled by controllers 35, 40 and 44 associated with each fryer pot. It will be understood throughout that the term oil or cooking oil refers to any liquid cooking medium, including melted shortening or even water for cooling vat systems for pasta, for example.

Housing 15 also contains a filtration system that is able to intermittently fill and filter oil in fryer pots 20, 25 and 30. Housing 15 and, in particular, each fryer pot contains sensors that are able to sense position of oil in fryer pot and replenished oil to each fryer pot. Housing 15 also has a new oil reservoir 60 and an indicator lamp 65 operatively associated with oil reservoir 60. Oil reservoir 60 uses new non-filtered oil to supply fryer pots 20, 25, and 30. Further the doors can also be opened and used for periodic maintenance necessary for commercial cooking systems. While housing 15 is shown having three fryer pots, the housing could contain as few as two and as many as twelve fryer pots depending upon the needs of the food service professional. Fryer pots 20, 25 and 30 are preferably low oil volume fryer pots of 30 pounds, although standard sized fryer pots may also be used.

Referring to FIGS. 1, 2 and 3, fryer pot 20 has a drain valve 155 that is opened and closed by one of a pair of actuators 130. Beneath fryer pot 20 is a drain manifold 56 that collects oil from drain valve 155. Manifold 56 collects oil from each drain valve in fryer system 10. Oil passes from drain manifold 56 to a crumb basket via downspout. After oil passes through a crumb basket, such oil is deposited in filter pan 73. Oil is pulled or pumped through a filter pad and a filter screen located in the bottom of filter pan 73.

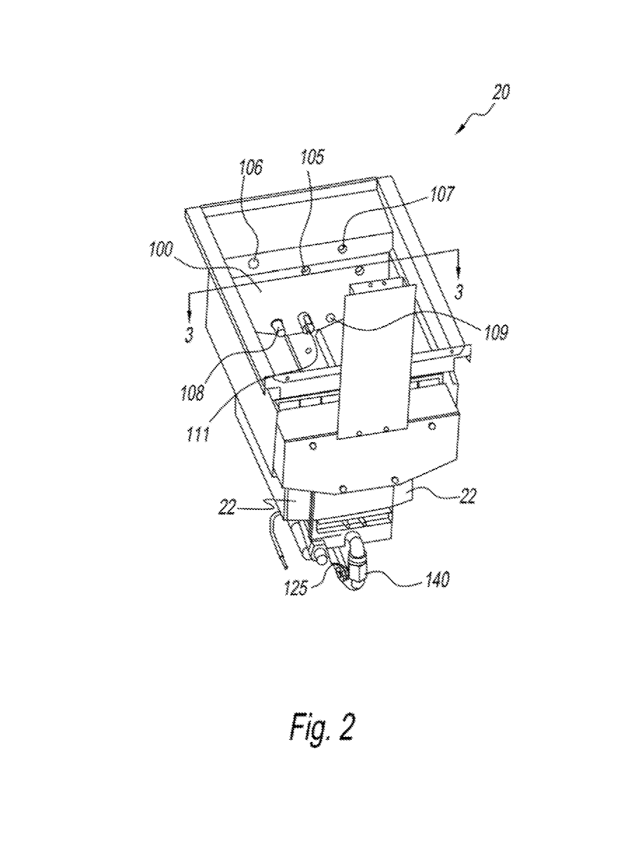

Referring to FIG. 2, an individual fryer pot 20 is shown. Fryer pots 25 and 30 of FIG. 1 each have the same elements and function as fryer pot 20. Fryer pot 20 has gas fired burners 22 for heating oil in a cooking area 100, although other methods of heating could also be used. Fryer pot 20 also has an oil level sensor 105, an optional safety backup submersible oil level sensor 106 and top off oil inlet 107. Fryer pot 20 also has a fryer high limit probe 108, an auxiliary heater probe heater 109 and a fryer temperature probe 111. Submersible sensors 105 and 106 may be bimetallic thermal sensors but could also be continuous temperature referencing sensors.

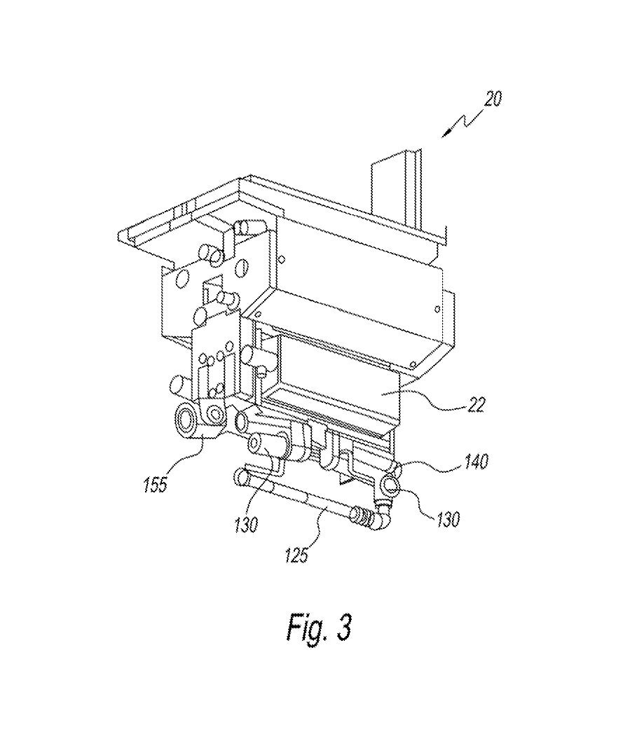

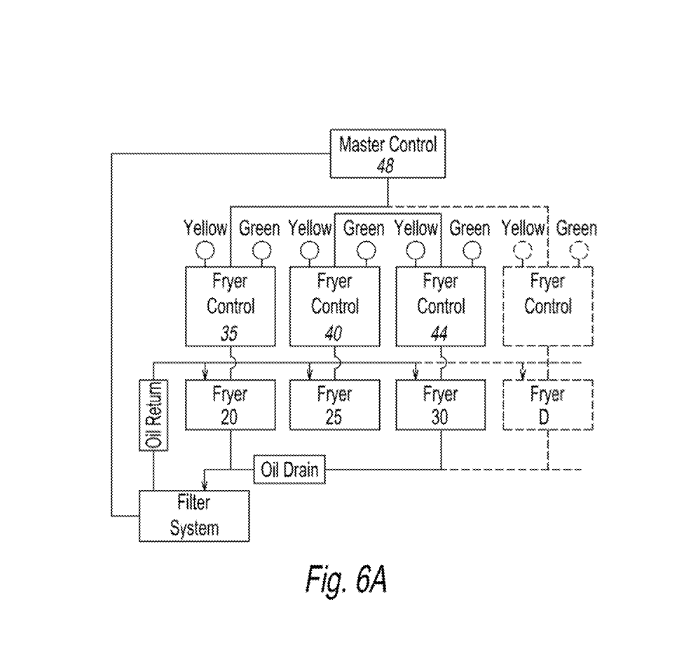

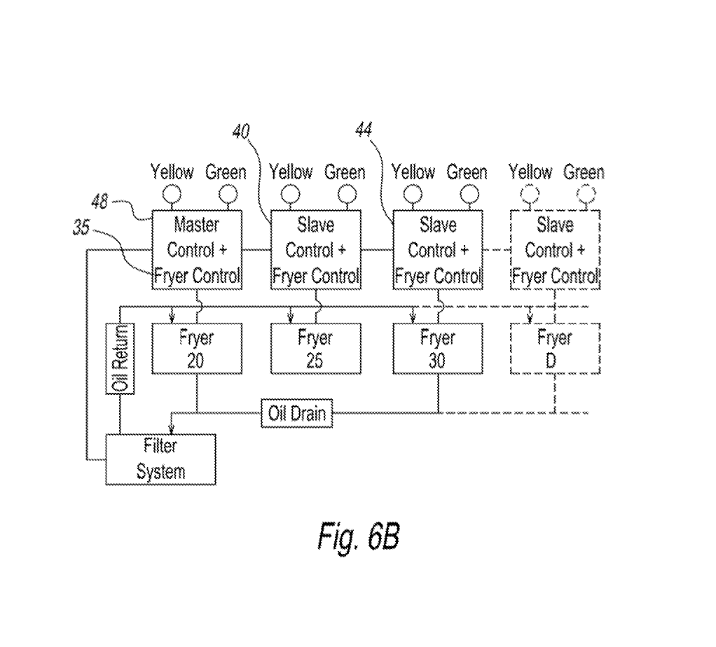

As shown in FIG. 3 and FIG. 6, fryer pot 20 has a drain valve 155 driven by one of a pair of actuators, for example, linear motion motors 130 to drain used oil from fryer pot 20. Fryer pot 20 also has a pipe system 125 that feeds used oil into fryer pot 20 via an oil return valve 140 driven by the other of the pair of linear motion motors 130. Fryer pot 20 has a remotely located solenoid valve 135 and pump 160 associated therewith that operates to feed new oil to fryer pot 20 through pipe system 165 terminating at top off inlet 107. System 10 has three solenoid valves 135, 145 and 150. Solenoid valves 145 and 150 are operatively connected to fill fryer pots 25 and 30, respectively, in response to submersible temperature sensors disposed in those fryer pots. Pump 160 uses a vacuum, pressure or centrifugally driven filtration process. The filtration process and oil transport activities can be automated through main controller 48 and executed by a user based on prompting or text instructions at each individual controller 35, 40 and 44.

Pipe system 165 is separate from pipe system 125 that feeds used oil to fryer pot 20. Pipe system 165 is in communication with new oil reservoir 60. Pipe system 165 is in fluid communication with reservoir 60, whereas piping 125 is in fluid communication with pan 73.

As shown in FIG. 1, new oil reservoir 60 may be a single tank, an interconnected series of tanks, a drum or any source of new oil. Reservoir 60 is in electrical communication with controller 48 to supply oil depending upon needs of a fryer pot 20, 25 and 30. For example, if an oil level in a particular fryer pot is low due to oil use, or a particular fryer pot needs rejuvenation due to deterioration, such controller would send a signal to supply pump 160 and valve to supply new oil to a particular fryer pot. The presence or level of oil in fryer system 10 can be based on temperature systems, pressure sensors, visually, with optic methods, heat dispersion, vibration or acoustic methods, although temperature sensors are presently disclosed. Independent of the method used, the level of oil in a fryer pot is conveyed to controller 48, which communicates with pump 160 and return valve 76, to maintain the oil level to a proper level in fryer pot 20, 25 or 30. Fresh oil reservoir 60 can be located inside fryer system 10 or remotely.

Filter pan 73 and valves 135, 145, and 155 and pump 160 support a polishing filtration function. The polishing filtration function occurs after a fryer pot is brought out of service by controller 48 once such fryer pot is not needed during a particular schedule. The polishing function is effective to remove water from cooking oil by passing used cooking oil for several minutes through the filtering system. As discussed previously, this process eliminates not only particulate matter, but significantly, minimizes water in the cooking oil. While a specific fryer pot has been described, the present methodology can be executed on fryer pots having a different configuration.

In addition to filter pan 73 that mechanically filters oil flowing through fryer system 10, non mechanical means are also usable within the scope of the present system. Filter aids such as magnesium silicate can be used to absorb certain harmful byproducts in addition to the filter in filter pan 73. While magnesium silicate absorbs a certain amount of oil which is discarded each time filter is discarded, beneficial effects of using magnesium silicate filtration significantly outweigh the cost of the oil discarded.

Significantly, when new oil is introduced into a single fryer pot, 20, for example, other fryer pots 25 and 30 benefit because the new oil will improve the net condition of the oil in the entire fryer system 10 because such new oil has the benefit not having particulate impurities, moisture, oxidation or repeated exposure to elevated temperatures. This new oil will ultimately be used in other fryer pots after the filtration process.

FIG. 6a shows a schematic diagram of fryer system 10. Fryer system 10 has a master controller 48 that controls fryer pots 20, 25 and 30 via fryer control 35, 40 and 44, respectively. Controller 48 coordinates all on and off times of fryer pots 20, 25 and 30 according to a predetermined schedule that is stored in a memory contained in controller 48. Further controller 48 manages all filtering operations of filtration system 11 according to the predetermined schedule.

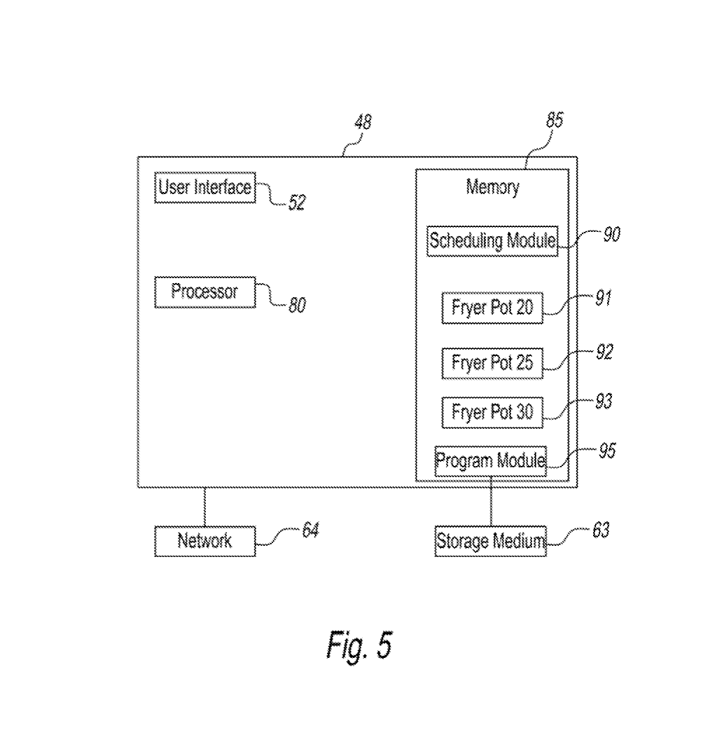

Referring to FIG. 5, shows controller 48 includes a user interface 52, a processor 80, and a memory 85. Controller 48 may be implemented on a general-purpose microcomputer. Controller 48 can accept various settings, such as, for example, temperature and timing settings. Controller 48 is capable of counting the number cook cycles processed in fryer pot 20. Although controller 48 is represented herein as a standalone device, it is not limited to such, but instead can be coupled to other devices (not shown) via a network.

Processor 80 is configured of logic circuitry that corresponds to and executes instructions to perform functions of present disclosure.

Memory 85 stores data and instructions for controlling the operation of processor 80. Memory 85 may be implemented in a random access memory (RAM), a hard drive, a read only memory (ROM), or a combination thereof. Components of memory 85 are program modules 90 through 93, for example. The term “module” is used herein to denote a functional operation that may be embodied either as a stand-alone component or an integrated configuration of a plurality of sub-component components. Thus, program module may be implemented as a single module or as a plurality of modules that operate in cooperation with one another. Moreover, although program modules are described herein as being installed in memory 85, and therefore being implemented in software, it could be implemented in any of hardware (e.g. electronic circuitry), firmware, software, or a combination thereof. Further, while program modules are indicted as already loaded into memory 85, it may be configured on a storage medium for subsequent loading into memory 85. Storage medium 63 can be any conventional storage medium that stores program module thereon in tangible form. Examples of storage medium 63 include a floppy disk, a compact disk, a magnetic tape, a read only memory, an optical storage media, universal serial bus (USB) flash drive, a digital versatile disc, or a zip drive. Alternatively, storage medium 63 can be a random access memory, or other type of electronic storage, located on a remote storage system and coupled to controller 48 via a network 64.

Scheduling module 90 stores the several cooking routines or schedules of the present disclosure that activate (turn on) and bring out of service (turn off) service fryer pots 20, 25 and 30 according to a predetermined sequence as will be described below. Program module 91 includes instructions related to menu items, cook temperatures and safety operations related to the fryer pot 20. Similarly, program modules 92 and 93 contain corresponding instructions for fryer pots 25 and 30, respectively. Processor 80 executes the instructions of program modules 91, 92 and 93 to control oil for fry pots 20, 25 and 30, respectively.

A program module 95 includes instructions to manage oil filtration of fryer pots 20, 25 and 30 and the opening and closing of valves and pumps. Accordingly, program module 95 counts the number of cook cycles registered in each fryer pot, includes instructions for communicating electronically with sensors in each fryer pot to monitor positioning of oil in each fryer pot, controlling motors and valves associated with each fryer pot and supplying oil to each fryer pot as needed. Program module 95 also includes instructions for managing the fill operation in each fryer pot to rejuvenate oil that is lost during the fryer process. Processor 80 executes the instructions of program module 95 for automatic control or manual control (via prompts) by an operator.

User interface 52 includes an input device, such as a keyboard or speech recognition subsystem for enabling a user to communicate information and command selections to processor 80. User interface 52 also includes an output device such as a display or printer to display text or other visual information to a user for instructional or status indication purposes. Additional function buttons or displays with text messages, audible alarms associated with displays and status lights as indicated in FIG. 1 above the number buttons, can be used to alert or inform the operator to perform a particular action or function.

Processor 80 provides outputs to user interface 52 based on execution of the instructions of program modules 90, 91, 92, 93 and 95 of the methods described herein.

Alternatively, and as shown in FIG. 6b, a fryer pot control, such as of fryer pot 20 incorporates a master control function that is able to control other fryer pots 30 and 35, for example.

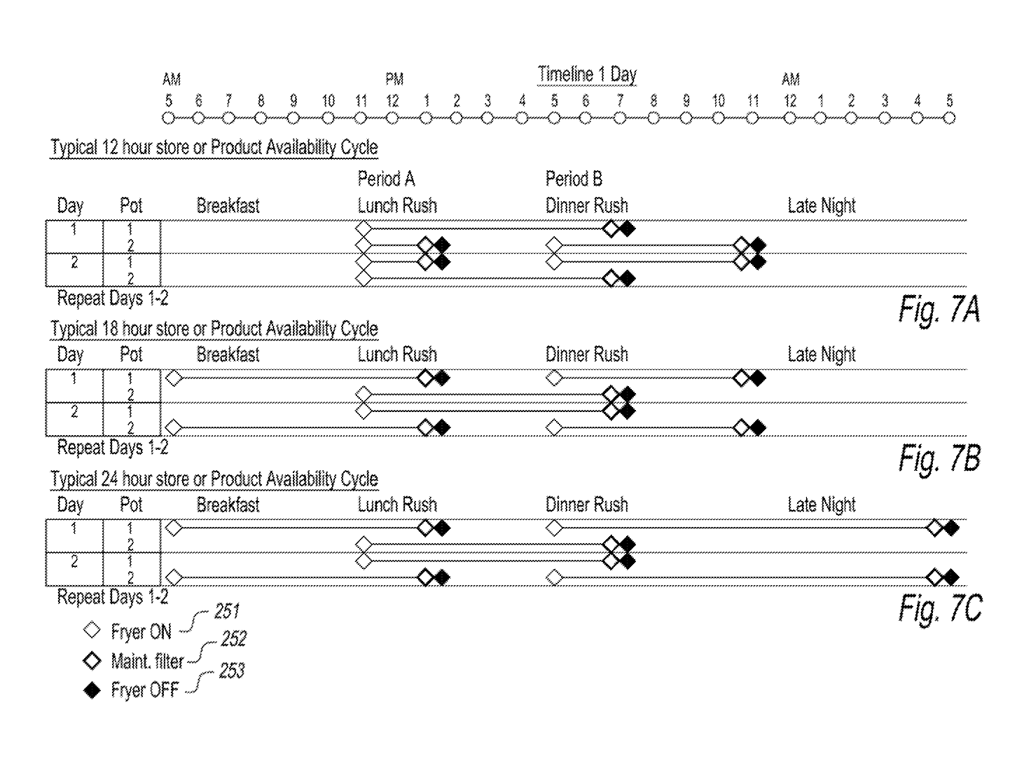

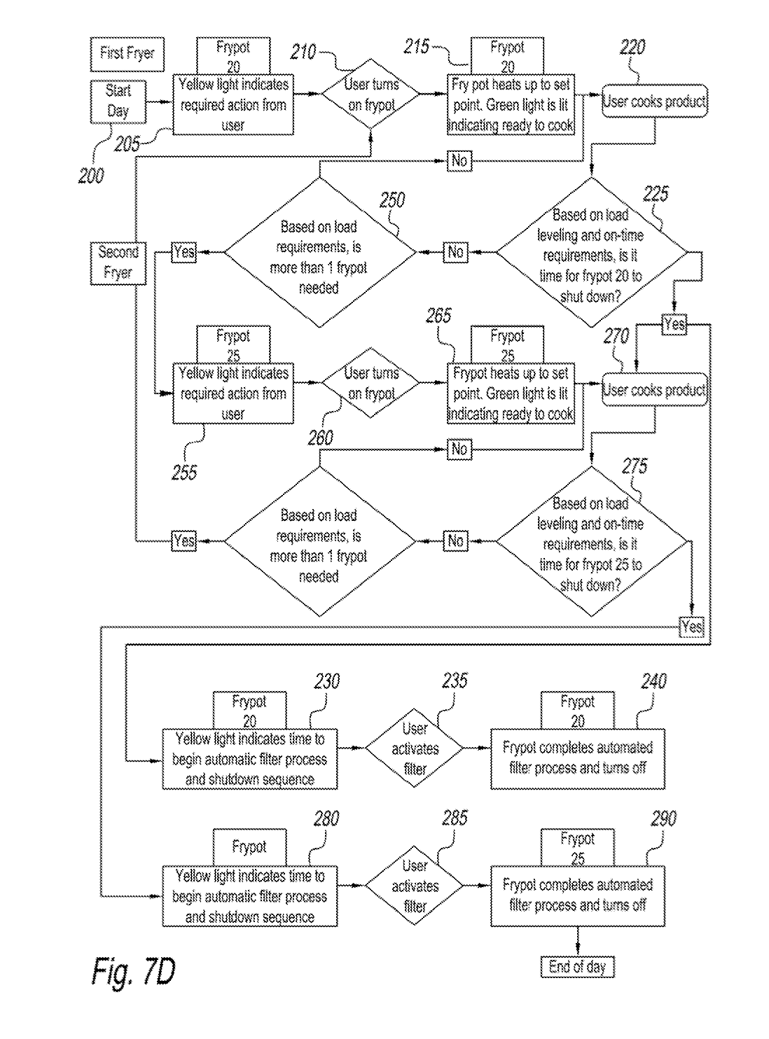

Referring to FIG. 7a, FIG. 7b and FIG. 7c, three different cooking schedules for a two fryer pot system are shown and described. A system, such as the one shown in FIG. 1 (with two fryer pots), guides a user via controller 48 to cook in designated fryers by a system of indicators, and to place fryers in an idle mode from a cook mode via indicators/text according to a predetermined cook capacity schedule, lights. As discussed previously, controller 48 controls overall functions such as cook scheduling function, fryer pot status (on/off, idle, in use, for example), whereas individual controls on each fryer pot manually control oil cooking/heating functions based on prompts provided by controller 48.

Cooking capacity requirements in many restaurants are known to have peaks at morning breakfast time, midday lunch time, and again for the evening meal time. Accordingly, in an exemplary system with two fryers, a schedule incorporating two available fryers during peak time is always maintained to address peak demand scenarios and once a peak demand period has passed, to quickly return to a single deep fryer by returning a non-used fryer to idle mode quickly after peak time has passed. Fryer system 10 also accommodates unforeseen scenarios such as a sudden increase in demand for additional fryer pots that can be quickly brought online by a process of rotating fryer pots in use after oil in such fryer pots has been treated or replenished.

In a venue with two fryer pots 20 and 25, various schedules according to the present disclosure are disclosed for cooking the same product. The various schedules represent a typical 12 hour store or product availability schedule, an 18 hour schedule and a twenty four hour schedule.

Referring to FIG. 7a, a pre-programmed schedule for a 12 hour day is shown. In a venue with two fryer pots, in a 12 hour cycle, that begins at lunchtime Period A, for example, two fryer pots 20 and 25 would be brought into service on Day 1. The user would be prompted with for example a light on user interface of control 35 and control 40, to turn on each fryer pot 20 and 25. In Period A, a period of high demand, two fryer pots 20 and 25 are required. After a predetermined rush period of approximately two hours, fryer pot 25, for example, would be automatically turned off by a signal sent from controller to fryer pot 25. After fryer pot 25 is turned off, controller 48 sends a signal to fryer pot 25 commence a filtration cycle. In keeping with the present disclosure, controller 48 manages the filtration cycle of fryer pot 25. During the filtration cycle, controller 48 sends signals to motors 130 that open drain valve 155 and return valve 140 of fryer pot 25. Controller 48 also sends a signal to motor 130 and pump 160 to enable a pump (not shown) to cycle oil through fryer pot 25 several times. This rapid pumping of oil through fryer pot 25, termed polishing, eliminates water from such oil and cools the oil that is pumped through filter and fryer plumbing. Polishing takes approximately from 7 to 15 minutes at the close of each cooking cycle. Polishing immediately stops the exposure of cooking oil to water and, therefore, minimizes the negative effects of water and rapidly cools the oil to minimize the exposure of the oil to elevated temperatures. Fryer pot 25 is then allowed to cool further naturally and remains in an off state until its next scheduled period of use.

Fryer pot 20 remains in a cooking mode until dinner rush period, Period B, is completed at approximately 7 pm. From 11 am to 7 pm, fryer pot 20 has been on for 8 hours. During this time period, cooking oil has been absorbed by the food product as part of the cooking process. Accordingly, during this 8 hour time period new oil is supplied to replenish oil in fryer pot 10. The oil is replenished based upon readings from sensors in fryer pot 20 that monitor position of cooking. Replenishment of oil helps to refresh the oil and minimize the effects of water and oxidization of the oil, in fryer pot 20 and fryer pot 25 that is also in use.

At Day 2 of FIG. 7a, fryer pot 25 is controlled to function as fryer pot 20 on Day 1 and fryer pot 20 is controlled to function as fryer pot 25 of Day 1. By effectively switching positions on alternate days, even use of cooking oil is maintained. Because fryer pots 20 and 25 use the same filtration system, even use of cooking oil must be maintained so that neither fryer pot is cross-contaminated by excessive TPMs, or excessive water or particulate matter from the other fryer pot.

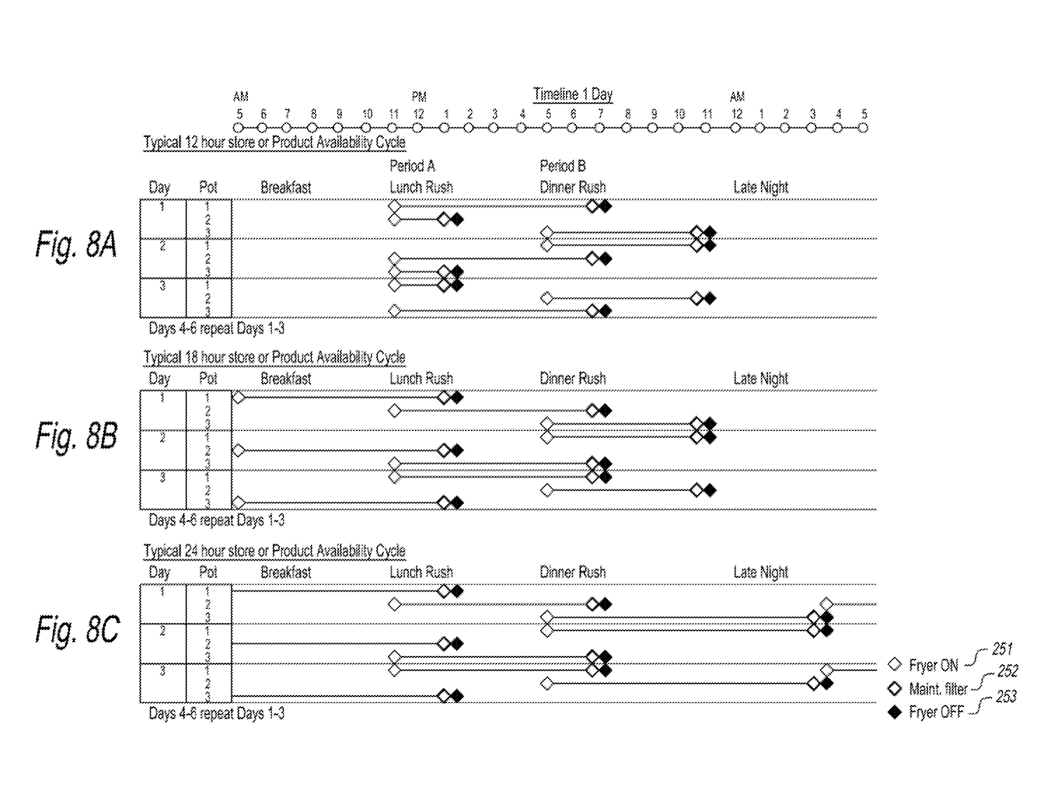

Referring to FIGS. 7b and 7c, fryer pots 20 and 25 are used for 18-hour days and 24 hour cooking days respectively. Their cooking cycles are substantially similar to the cooking schedules of the 12 hour cooking schedule highlighted above with respect to FIG. 7a. The only difference between FIG. 7a and FIGS. 7b and 8c is that the breakfast period is extended in FIG. 7b and the breakfast and dinner periods are extended in FIG. 7c.

In FIG. 7b and FIG. 7c, fryer pot 20 and fryer pot 25, are turned on at 5 am. In FIG. 7b, fryer pots 20 and 25 are turned off at 11 pm. In the 24 hour schedule shown in FIG. 7c, fryer pots 20 and 25 are rotated in and out of service to maintain cooking availability.

However, there exist times when a schedule such as the one shown in FIGS. 7a through 7c is not used or for unforeseen reasons, such as excessive demand, that a different method may be used.

The flow chart shown in FIG. 7d shows how operation that is unplanned would function according to the present disclosure. Fryer pot 20 and fryer pot 25 are brought in and out of service during the intense rush of lunchtime and dinner time. In periods which typically experience minimal demand, only a single fryer pot is used to minimize exposure of cooking oil to elevated temperatures and to avoid the deleterious effects of the cooking process noted previously. It should be noted that if an emergency situation occurs where additional fryer capacity is required that the process allows for an unscheduled fryer to be heated. However, as soon as the emergency situation is over the fryer pot should be processed through the shutdown process of turning off the heat, polish filtering and shutdown.

In FIG. 7d, the diamonds labeled 251 indicate “fryer on”, the diamonds labeled 252 indicate “fryer maintenance (e.g., filtration), and the diamonds labeled 253 indicate fryer off. As an example, the diamonds are so labeled only in FIG. 7a for day 1 of a typical 12 hour store or product available cycle. Thus, fryer pots 1 and 2 are both turned on at 11 am as indicated by diamonds 251. Fryer pot 1 stays on until 7 pm and is then turned off as indicated by diamond 253. Fryer pot 2 is turned off at 1 pm as indicated by diamond 253 and turned on again at 5 pm as indicated by diamond 251 and turned off again at 11 pm. When turned off, the diamonds 252 indicate that the turned off fryer pot is available for maintenance such as filtration and/or polishing, if required.

In a venue with two fryer pots 20 and 25, controller 48 supplies the user with a prompt to turn on power to fryer pot 20. An indicator, such as an LED, is illuminated on user interface 52 of fryer pot 20 at controller 35 to indicate that an action is required from user at step 205. At step 210, the user turns on fryer pot 20 to cook a desired food product. Individual fryer pot 20 (and 25) is programmed with menu items and specific cook temperatures (set points) and times, as noted above. At step 215, user interface 52 of fryer pot 20 provides an indication, such as by a green LED, that fryer pot 20 is prepared to cook because the cooking oil has reached the preset temperature. At step 220, fryer pot 20 cooks food products for a period of time and temperature of oil in fryer pot remains at preprogrammed set temperature to cook the food product. At step 225, computer 48 (or user if in manual mode) determines if fryer pot 20 should be shut down or if cooking should continue based upon the number of cooking cycles that have elapsed. The decision is based on the oil quality and the current needs in the restaurant environment. If controller 48 determines that a predetermined number of cook cycles has elapsed, an affirmative result will commence a filtration cycle at step 230. If on the other hand, the oil in fryer pot 20 is adequately free of impurities and a single fryer pot is still required, use of such fryer pot is still needed at step 250, cooking will continue at step 220. If a second fryer pot is needed at step 250, controller 48 sends a signal to the user at step 255 requesting the user to turn on fryer pot 25. At step 260, fryer pot 25 is turned on. At step 265, oil is heated in fryer pot 25 and when the oil reaches a predetermined set point temperature, a light on user interface 52 of fryer pot 25 is illuminated indicating that oil in fryer pot 25 is at a predetermined set temperature for cooking.

The food is cooked in fryer pot 25 at step 270. At step 275, computer 48 (or user if in manual mode) determines if fryer pot 25 should be shut down or if cooking should continue based upon the number of cooking cycles that have elapsed. The decision is based on the oil quality and the current needs in the restaurant environment. If controller 48 determines that a predetermined number of cook cycles has elapsed, controller 48 sends a signal to fryer controller 40 that illuminates an LED indicating to the user that a filtration cycle must commence at step 280 for fryer pot 25. At step 285, user activates filtration cycle. At step 290, fryer pot 25 may be turned off, such as at the end of a cooking day, or placed in an idle mode for further use. If on the other hand, the oil in fryer pot 25 is adequately free of impurities and a single fryer pot is still required cooking, fryer pot 25 is needed at step 275, cooking will continue using fryer pot 25 at step 270.

FIG. 8a through FIG. 8c illustrate cooking schedules of three fryer pot In a venue with three fryer pots, various schedules according to the present disclosure are disclosed for cooking the same product. The various schedules represent a typical 12 hour store or product availability schedule, and 18 hour schedule and a twenty four hour schedule. Controller 48, as described with regard to FIGS. 7a through 7c, controls overall functions such as cook scheduling function, fryer pot status (idle, in use, for example), whereas individual controls 35, 40 and 44 control oil monitoring/testing functions, cooking/heating functions, in each fryer pot 20, 25 and 30.

According to FIG. 8a, a 12 hour cooking cycle, the schedule is executed according to a pre-programmed schedule. As noted previously, memory 85 stores data and instructions for use by processor 80 controlling the operation of system 10. Processor 80 is configured of logic circuitry that corresponds to and executes instructions to perform the functions of the present disclosure.

In a venue with three fryer pots, in a 12 hour cycle, that begins at lunchtime Period A, for example, fryer pots 20 and 25 would be turned on by the user. The user would be prompted with, for example, a light on user interfaces 52 to turn on each fryer pot 20 and 25. During rush period, two fryer pots 20 and 25 are required. After a predetermined rush period of approximately two hours, fryer pot 25, for example, would be automatically turned off by a signal sent from controller 48 to controller 35. After fryer pot 25 is turned off, controller 48 sends a signal to fryer pot 25 to commence a filtration cycle. In keeping with the present disclosure, controller 48 manages the filtration cycle of fryer pot 25. During the filtration cycle, controller 48 sends signal to motors 130 that open drain valve 155 and return 140 valve of fryer pot 25. Controller 48 also sends a signal to motor (not shown) and to enable a pump (not shown) to cycle oil through fryer pot 25 several times. This rapid pumping of oil through fryer pot 25, termed polishing, eliminates water from such oil and cools the oil that is pumped through filter and fryer plumbing. Polishing immediately stops the exposure of cooking oil to water and therefore minimizes the negative effects of water and rapidly cools the oil to minimize the exposure of the oil to elevated temperatures. Fryer pot 25 is then allowed to cool further naturally and remains in an off state until its next scheduled period of use.

Fryer pot 20 remains in a cooking mode until dinner rush period, Period B, is completed approximately at approximately 7 pm. From 11 am to 7 pm, fryer pot 20 has been in use for 8 hours. During this time period, such oil has been replenished based on readings from sensors that monitor position of cooking oil. Replenishment of oil helps to freshen the oil and minimize the effects of water and oxidization of the oil.

At dinner rush, Period B, two fryer pots must be in service to accommodate the necessary increased load of consumers. Accordingly, controller 48 executes instructions that automatically bring fryer pot 30 into use, cooking oil is heated and is available for cooking food product. After the two hour time period of Period B, fryer pot 20 is brought out of service so that such oil contained in such fryer pot is filtered. Several hours later, at 11 pm, fryer pot 30 is brought out of service and oil in fryer pot 30 is filtered.

On Day 2 of FIG. 8a, fryer pots 25 and 30 are turned on, and fryer pot 20 is not turned on until 5 pm. In other words on Day 2, fryer pot 20 is controlled by controller 48 to take the position that fryer pot 30 occupied on Day 1, fryer pot 25 is controlled by controller 48 to take the position that fryer pot 20 had on Day 1 and fryer pot 30 is controlled by controller 48 to take the position that fryer pot 25 had on Day 1. FIG. 8a shows that the first fryer pot used on successive days is not the same. The first fryer pot used is rotated from Day 1, to Day 2 and to Day 3. The benefit of rotating the first fryer pot used in a day, such as fryer pot 25 on day 2, is that such fryer pot obtains the benefit of lowered volume of oil and a clean filter. The benefit of the lowered volume of oil means that such fryer pot will receive new oil to replenish such oil that was lost to the filter.

On Day 3, again the position of the fryer pots is shifted so that fryer pot 20 and fryer pot 30 are used and fryer pot 25 starts at 5 pm for cooking during Period B.

Referring to FIGS. 8b and 8c, three fryer pots are used for 18-hour days and 24 hour cooking days, respectively. The cooking cycles are substantially similar to the cooking schedules of the 12 hour cooking schedule highlighted above with respect to FIG. 8a. The only difference between FIG. 8a and FIGS. 8b and 8c is that the breakfast period is extended in FIG. 8b and the breakfast and dinner period is extended in FIG. 8c. In FIG. 8b, the breakfast begins at 5 am. In the evening in FIG. 8c, dinner extends until 3 am and the fryer pots are constantly in rotation operating during an entire 24-hour period.

Similar to FIGS. 8a through 8c, FIGS. 9a through 9c, 10a through 10c and 11a through 11c, three fryer pots are in a preprogrammed cooking rotation or schedule that is stored in memory 85 of controller 48.

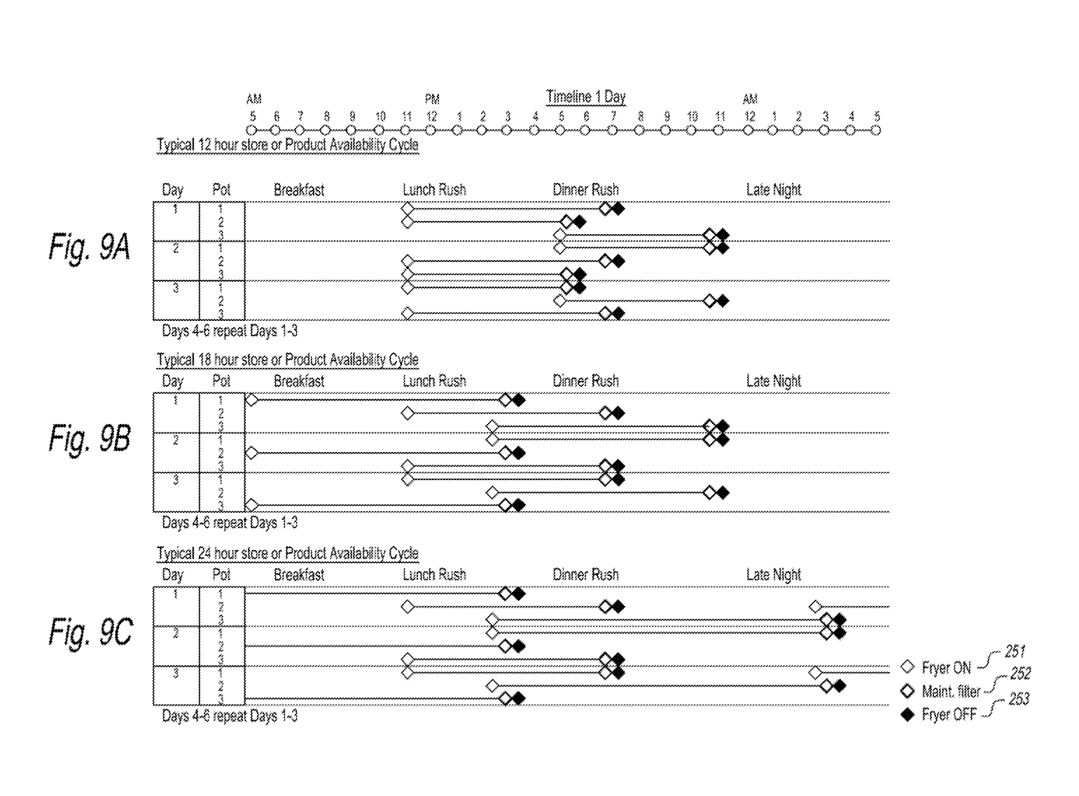

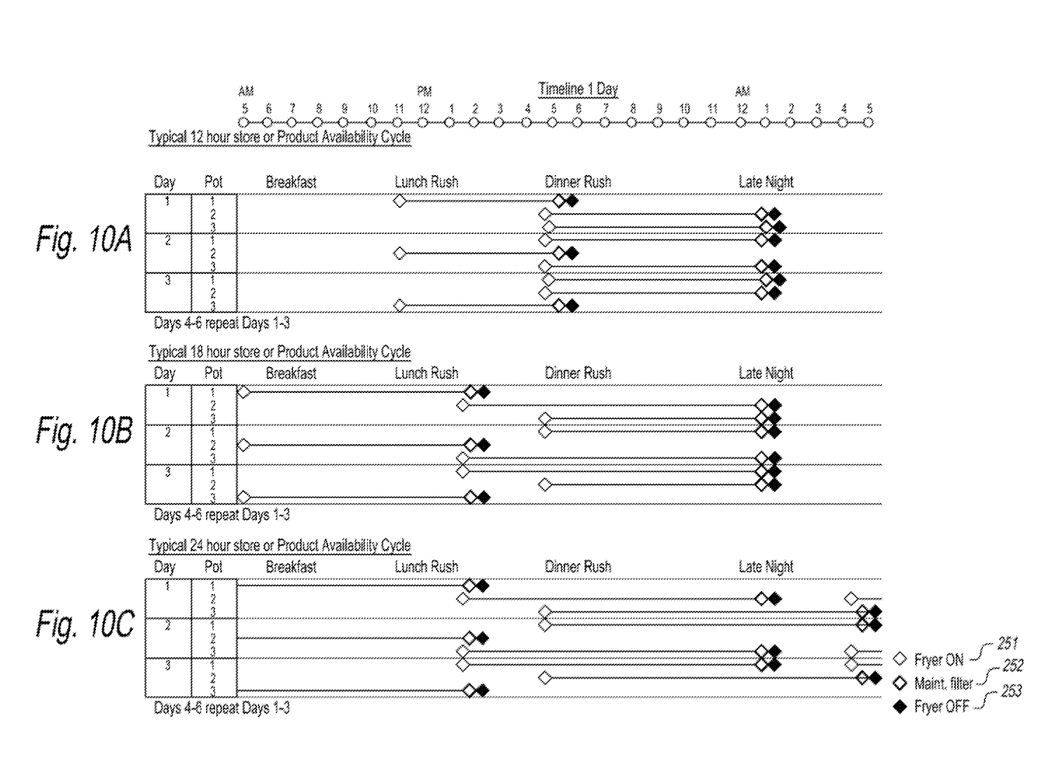

In FIGS. 9a through 9c, such a schedule is used in environments that have a lunch rush and dinner rush lasting from 11 am to 7 pm during which at least two and eventually three fryer pots 20, 25 and 30 are in operation. FIG. 9a is a 12 hour product availability cycle; FIG. 10b is an 18-hour product availability cycle and FIG. 9c is a 24 hour availability cycle.

In FIGS. 10a through 10c, such as schedule is used in an environment that has a heavy evening demand from 5 pm to 12 am for example. Again during this period, all three fryer pots 20, 25 and 30 may be in operation to accommodate consumer volume. FIG. 10a is a 12 hour product availability cycle; FIG. 10b is an 18-hour product availability cycle and FIG. 10c is a 24 hour availability cycle.

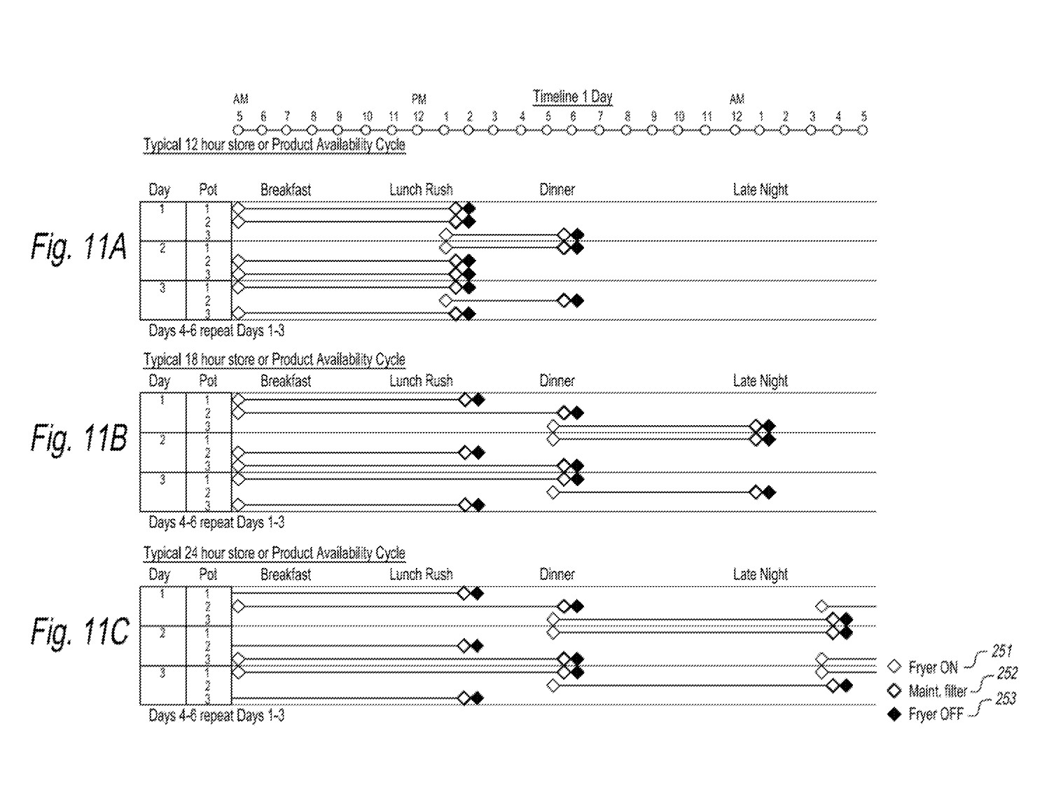

In FIGS. 11a through 11c, such as schedule is used in an environment that has a heavy breakfast demand from 5 am to 12 pm for example. Again during this period, all three fryer pots 20, 25 and 30 may be in operation to accommodate consumer volume. FIG. 11a is a 12 hour product availability cycle; FIG. 11b is an 18-hour product availability cycle and FIG. 11c is a 24 hour availability cycle.

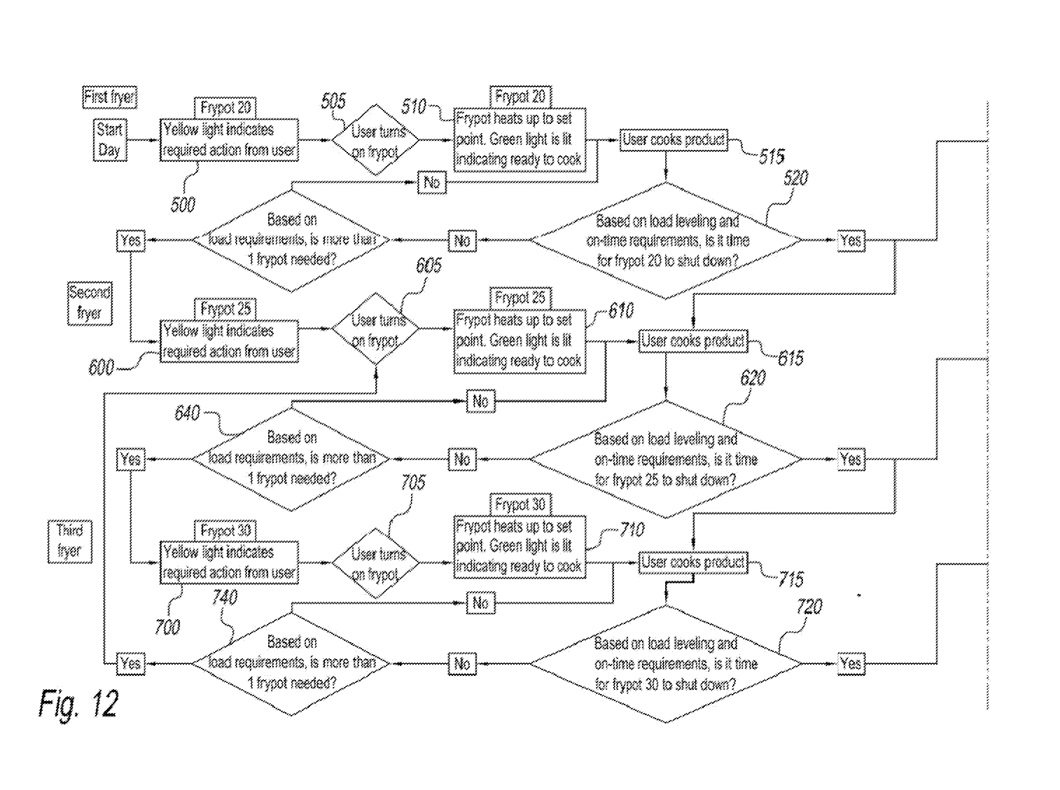

The flow chart shown in FIG. 12 shows how operation that is unplanned would function according to the present disclosure in a system with three fryer pots. Fryer pot 20, fryer pot 25 and fryer pot 30 are brought in and out of service during the intense rush of lunchtime and dinner time. In periods which typically experience minimal demand, only a single fryer pot is used to minimize exposure of cooking oil to elevated temperatures and to avoid the deleterious effects of the cooking process noted previously. It should be noted that if an emergency situation occurs where additional fryer capacity is required that the process allows for an unscheduled fryer to be heated. However, as soon as the emergency situation is over the fryer should be processed through the shutdown process of turning off the heat, polish filtering and shutdown.

FIG. 12 shows a flow chart that describes how a non-programmed venue with three fryer pots would operate. At step 500, controller 48 supplies power to fryer pot 20. An indicator, such as an LED, is illuminated on user interface (of fryer pot 20) to indicate that an action is required from user. At step 505, user turns on fryer pot 20 to cook a desired food product. Individual fryer pots 20, 25 and 30 are programmed with menu items and specific cook temperatures (set points) and times, as noted above. At step 510, user interface 52 of fryer pot 20 provides an indication, such as by a green LED, that fryer pot 20 is prepared to cook because cooking oil has reached preset temperature. At step 515, fryer pot 20 cooks food products for a period of time and temperature of oil in fryer pot 20 remains at the preprogrammed set temperature to cook the food product. If processor 80 determines that a filtration cycle is necessary at step 520, processor 80 sends a signal to controller 30 indicating that an automatic filtration cycle should commence. At step 530, the user commences a filtration cycle. At step 535, fryer pot 20 can be placed in a turned off or in an idle mode. The decision is based on the oil quality and the current needs in the restaurant environment. If the computer 48 determines that a predetermined number of cook cycles has elapsed, an affirmative result will commence a filtration cycle at step 230.

If, on the other hand, the oil in fryer pot 20 is adequately free of impurities and a single fryer pot is still adequate as determined at step 525, cooking will continue at step 520. If a second fryer pot is needed at step 525, controller 48 sends a signal to control 40 that illuminates a light of control of fryer pot 25 to prompt an action by user at step 600. At step 605, the user turns on fryer pot 25. At step 610, oil is heated in fryer pot 25 and a light on user interface 52 of fryer pot 25 is illuminated indicating that oil in fryer pot 25 is at a predetermined set temperature for cooking.

At step 615, fryer pot 25 cooks food products for a period of time and the temperature of oil in fryer pot 25 remains at a preprogrammed set temperature to cook the food product. If processor 80 determines that a filtration cycle is necessary at step 620, controller 48 sends a signal to controller 40 indicating that an automatic filtration cycle should commence. At step 625, controller 40 provides an indication on the associated user interface 52 for the user to begin an automatic filtration cycle. At step 630, the user commences a filtration cycle. At step 635, fryer pot 25 can be placed in a turned off mode or in an idle mode. The decision is based on the oil quality and the current needs in the restaurant environment. If the processor 80 determines that a predetermined number of cook cycles has not elapsed, or that fryer pot 25 is still needed and two fryer pots are adequate, cooking will continue in fryer pot 25 at step 620.

Cooking can continue with a third fryer pot 30 according to the methodology highlighted above. At step 700, processor 80 sends a signal to illuminate a light on user interface 52 of fryer pot 25 indicating to the user that fryer pot 25 is needed. Accordingly, at step 705, the user turns on fryer pot 25. At step 710, oil is heated in fryer pot 25 and a light on user interface 52 of fryer pot 25 is illuminated indicating that the oil in fryer pot 25 is at a predetermined set temperature for cooking.

At step 715, fryer pot 30 cooks food products for a period of time and the temperature of oil in fryer pot remains at a preprogrammed set temperature to cook the food product. If processor 80 determines that a filtration cycle is necessary at step 720, controller 48 sends a signal to controller 44 indicating that an automatic filtration cycle should commence. At step 725, controller 44 provides an indication for the user to begin automatic filtration cycle. At step 730, the user commences a filtration cycle. At step 735, fryer pot 25 can be placed in a turned off mode or in an idle mode. The decision is based on the oil quality and the current needs in the restaurant environment. If the processor 80 determines that a predetermined number of cook cycles has not elapsed, or that fryer pot 30 is still needed and three fryer pots are adequate, cooking will continue in fryer pot 30 at step 720. While fryer pot 30 is cooking, fryer pots 20 and/or fryer pot 25 may be taken out of service.

On the following day, the first fryer to begin cooking is fryer 25, to take advantage of the benefits of a new filter and lowered volume of oil.

In keeping with the present disclosure, controller 48 manages the filtration cycle of fryer pots 20, 25 and 30 for a three fryer pot system. During a filtration cycle, controller 48 sends signals to motors 130 that open drain valve 155 and return valve 140 of fryer pot 20. Controller 48 also sends signals to motor [what motor?] and pump 160 to enable pump 160 to cycle oil through fryer pot 20 several times. This rapid pumping of oil through fryer pot 20, termed polishing, eliminates water from such oil and cools the oil that is pumped through filter and fryer plumbing. Polishing immediately stops the exposure of cooking oil to water and therefore minimizes the negative effects of water and rapidly cools the oil to minimize the exposure of the oil to elevated temperatures. Fryer pot 20 is then allowed to cool further naturally and remains in that state until its next scheduled period of use. Alternatively at step 240, fryer pot 20 is turned off by controller 48.

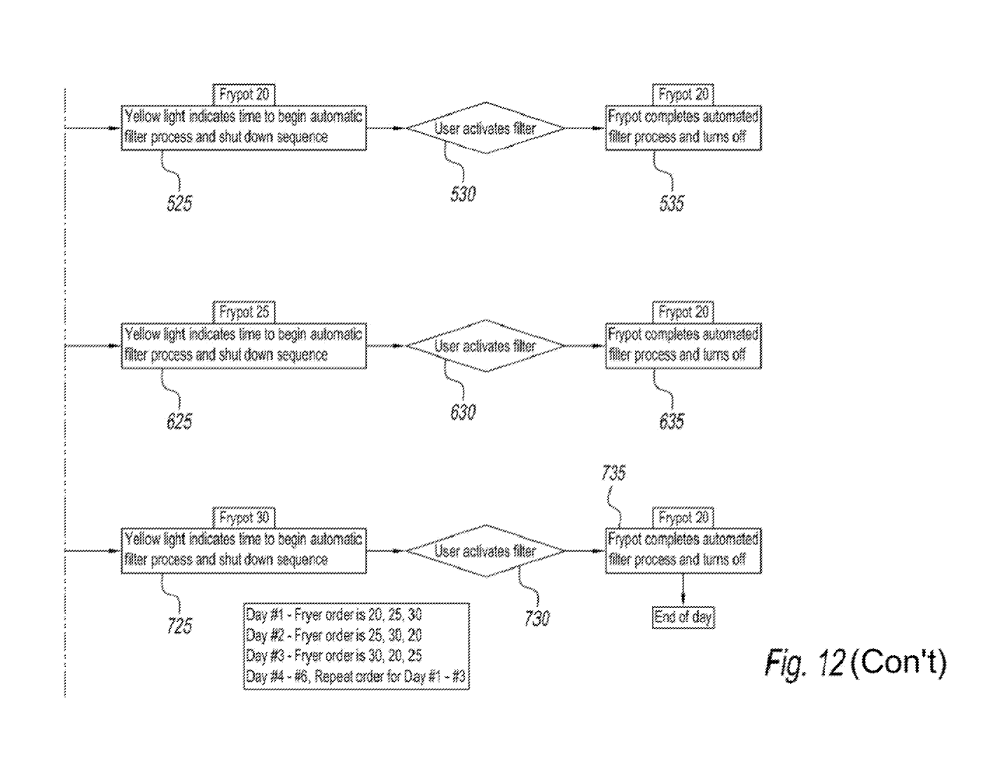

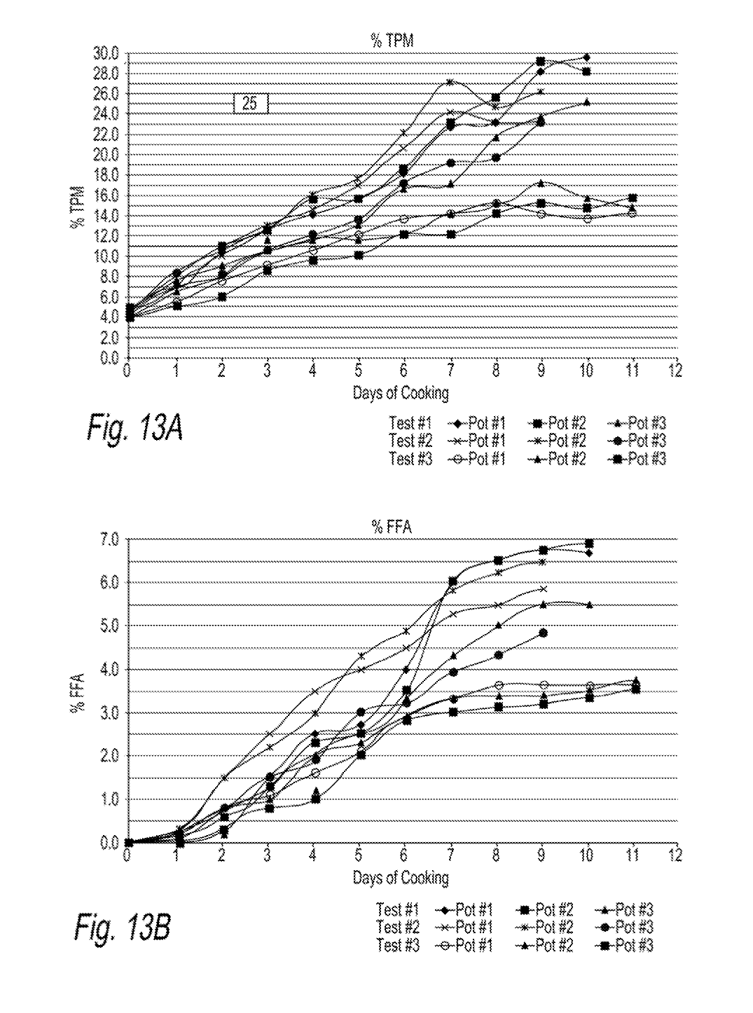

FIG. 13a shows a comparison between total polar materials present in a contaminated store unit and a store unit using a schedule disclosed herein.

FIG. 13b is a graph of a comparison of the percentage of free fatty acids between a contaminated store unit using a schedule disclosed herein

While the instant disclosure has been described to incorporate electric actuators, either hydraulic or pneumatic actuators could also be used for opening and closing the drain and return valves of the instant disclosure.

It should be understood that the foregoing description is only illustrative of the present invention. Various alternatives and modifications can be devised by those skilled in the art without departing from the scope of the present invention. Accordingly, the present invention is intended to embrace all such alternatives, modifications and variances.

What is claimed is:

1. A fryer system comprising:
a plurality of fryer pots;
a filtration system that filters oil used in said fryer pots; and
a controller that controls an on time use and an off time of said fryer pots according to a use schedule that levels the on time use among said plurality of fryer pots over a period of two or more days.

2. The fryer system of claim 1, wherein the on time use of said fryer pots is equalized over said period.

3. The fryer system of claim 1, wherein said use schedule rotates the on time use of said fryer pots from one to the next of said days.

4. The fryer system of claim 1, wherein said on time use of two or more of said plurality of fryer pots overlaps one another during a rush time.

5. The fryer system of claim 1, wherein any of said plurality of fryer pots that is not presently being used is controlled to an off status or an idle status.

6. The fryer system of claim 1, wherein said controller arranges for said filtration system to filter oil contained in one of said fryer pots that is not presently in use based on an elapse of a predetermined number of cook cycles of said one of said fryer pots since the oil was last filtered.

7. The fryer system of claim 6, wherein said controller further arranges for the oil to be cycled several times through said one of said fryer pots in a polishing process to remove water from the oil.

8. The fryer system of claim 1, wherein said controller comprises a processor that executes instructions stored in a memory to control said on time use and said off time of said plurality of fryer pots.

9. The fryer system of claim 8, wherein each of said fryer pots comprises a user interface and local controller; wherein said processor communicates prompts to said user interfaces for the operator to initiate actions via the local controller to control the associated fryer pot, said actions including turn on, turn off, oil filtration, polish oil and add new oil.

10. A method for a fryer system that comprises a plurality of fryer pots and a filtration system, said method comprising:
executing instructions with a processor for control of an on time use and an off time of said fryer pots according to a use schedule that levels the on time use among said plurality of fryer pots over a period of two or more days; and
sending prompts to an operator of said fryer system to turn said fryer pots on and off and to start and stop a filtering of the oil of an off time fryer pot.

11. The method of claim 10, further comprising generating a prompt for filtering the oil of said stopped fryer pot based on an elapse of a predetermined number of cook cycles of said off time fryer pot since the oil was last filtered.

12. The method of claim 10, further comprising:
after filtering, polishing the oil of the stopped fryer pot.
